(19) United States
(12) Patent Application Publication
(10) Pub. No.: US 2011/0285139 A1
(43) Pub. Date: Nov. 24, 2011

(54) Windflow modification into electricity-generating wind turbines

(75) Inventor: Pasquale Gregory Falbo, Boerne, TX (US)

(73) Assignee: PASQUALE GREGORY FALBO, BOERNE, TX (US)

(21) Appl. No.: 13/068,685

(22) Filed: May 18, 2011

Related U.S. Application Data
(60) Provisional application No. 61/396,130, filed on May 24, 2010.

(51) Int. Cl. F03D 1/04

(52) U.S. Cl. 290/55

(57) ABSTRACT

What is new regarding this application is only the physical act of attaching a lightweight material, hollow, subsonic wind-tunnel-shaped structure to any existing electricity-generating wind turbine's rotating base at the top of the tower or rotating generator, physical parameters permitting. An increase in the speed of the airflow at the repositioned propeller at the throat of the attached wind tunnel allows for low, ambient wind conditions to be increased at the propeller thus increasing the rotational speed of the propeller thus the useful electricity-generating efficiency and capacity of the turbine.

DIAGRAM: See attached three pages.

DECLARATION: See attached three pages.

NOTE: Privacy Act Statement attached.

### CROSS-REFERENCE TO RELATED APPLICATIONS

Previous Provisional Application No.: 61/396,130, dated May 24, 2010.

This application is to obtain a nonprovisional utility patent on the above provisional application.

### STATEMENT REGARDING FEDERALLY-SPONSORED RESEARCH OR DEVELOPMENT

I know of no federally-funded research associated with this application.

### REFERENCE TO SEQUENCE LISTING, A TABLE, OR COMPUTER PROGRAM LISTING COMPACT DISK APPENDIX

Not applicable.

### BACKGROUND OF THE INVENTION

While obtaining an Aerospace Engineering Bachelor's Degree, I designed, built and tested a supersonic wind tunnel as part of a class project.

Watching large electricity-generating wind turbines in West Texas, I noticed an ambient-wind velocity insufficient to turn the larger turbine propellers. I then realized how the ambient windflow velocity could be increased at the propeller by attaching a non-mechanical, hollow, lightweight, subsonic wind-tunnel-shaped structure to the rotating base at the top of the tower outside of and around the propeller/generator/support or the rotating generator unit and strut so that this unit is positioned at the “throat” of the wind tunnel, the position in the tunnel where the wind velocity is at its increased maximum. (See “Bernoulli's Principal”). This action could require no major modifications to any existing wind-turbine other than modifying the propeller/generator/support strut unit sizes and attaching a proportionally-sized tunnel to this modified unit.

Note: It seems impractical that this application would be feasible on large-propeller turbines, but would be more feasible on smaller, individually-operating turbine generators for small businesses or residences. However, this concept may even allow for smaller, faster-rotating propellers on the larger turbines to produce the same desired electrical output with a smaller propeller/generator unit, thus saving manufacturing costs, weight considerations and maintenance requirements, etc.

### BRIEF SUMMARY OF THE INVENTION

Previously-Existing Problems: Lack of ambient windflow speed to turn turbine propellers.

The major concept involved is increasing the ambient windflow velocity at the location of the propeller of any existing wind turbine without energy-using mechanical assistance. This is accomplished by attaching a lightweight material, hollow, subsonic wind-tunnel shaped structure on top of any wind turbine's rotating base or rotating generator at the top of the tower, physical parameters permitting. This design would enclose the existing propeller/generator/support strut unit or rotating generator near the “throat” (the smallest interior diameter) of the tunnel where wind velocity in the tunnel is at its increased maximum, thus increasing the rotational speed of the propeller and the generator's electrical output. This is this application's improvement to existing technology.

### BRIEF DESCRIPTION OF THE SEVERAL VIEWS OF THE DRAWING

NOTE: The descriptions of the attached diagram views below are only one example of any method the wind tunnel may be attached to the tower.

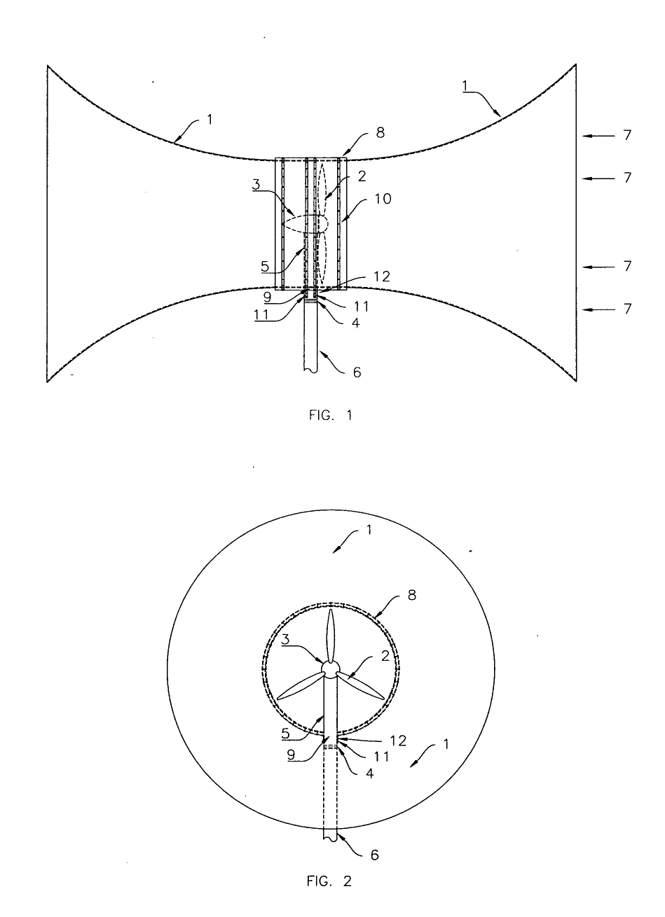

“FIG. 1” is a side view of the lightweight-material wind tunnel attached to a turbine tower's rotating base showing the propeller/generator/support strut unit at the “throat” of the wind tunnel (the minimum interior-diameter opening dimension of the tunnel) where wind velocity is at its increased maximum through the tunnel.

“FIG. 2” is a front view of the structure showing the wind tunnel and strut supporting the propeller/generator unit on the interior of the attached wind tunnel at its throat.

NOTE: The existing single, vertical propeller/generator support strut, all Figures Legend No. 5, also carries wiring from the generator to the interior of the tower to any existing rotating-electrical-pick-up device attached inside the tower which not need be modified to add the wind tunnel.

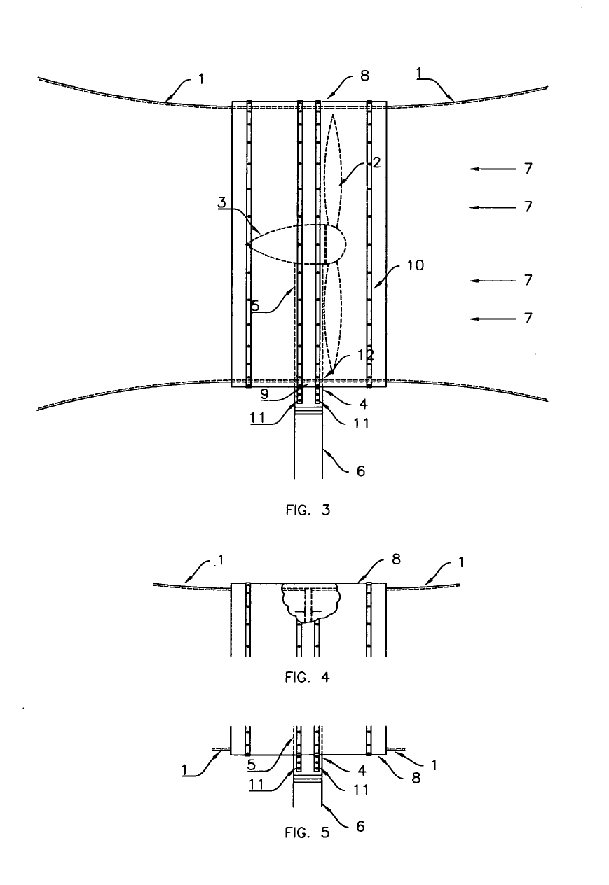

“FIG. 3” shows a closer detail of the wind turbine mounted within the “throat” section of the wind tunnel.

“FIG. 4” shows the wind-tunnel's mid-point break where the two sections come together within the confines of the exterior collar and associated full-circle external straps to secure the two tunnel sections into one unit for mounting on the wind turbine's rotating base.

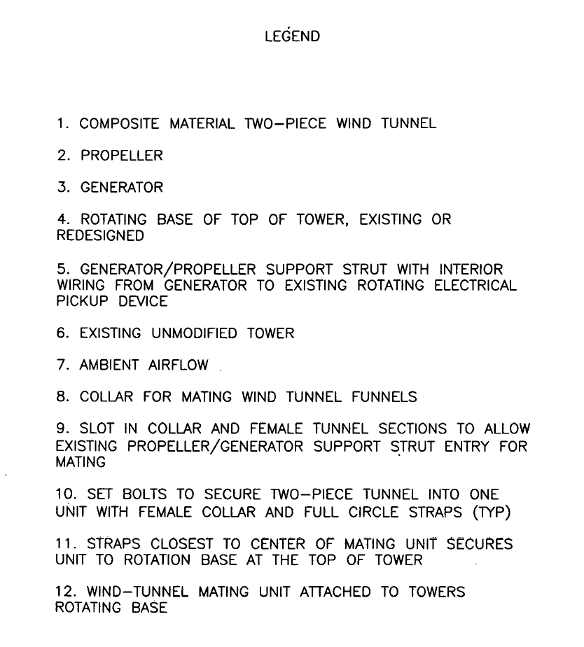

“FIG. 5 shows the completed joined-in-the-collar tunnel sections unit with the associated exterior straps secured to the tower's rotating base.

### DETAILED DESCRIPTION OF THE INVENTION

Take a lightweight material, hollow, subsonic wind-tunnel shaped structure (e.g.: two megaphones joined together at the smaller openings), and cut it in half at its smallest interior diameter, the “throat” of the tunnel. This would be after the two separate tunnel halves are formed in such a way that the two separate pieces may be joined together inside a joining collar in a bolt-together-type joint as shown in the Diagram FIG. 4. This two-piece configuration allows the tunnel to be attached to the tower without removing the existing propeller/generator unit although the propeller/generator unit may have to be downsized to fit into an appropriately-sized tunnel. One of the tunnel parts and joining collar would have a slot formed in them so that it may be positioned to fit around the existing propeller/generator support strut attached to the existing rotating base at the top of the tower.

If the generator is the rotating unit of the turbine, the tunnel joined unit can be mated to the generator itself in any feasible manner.

The lightweight-material, two-piece wind tunnel may be attached into one unit in the joining collar at the middle (throat) of the tunnel (See Drawings, “FIG. 4”). This should allow tunnel attachment to the rotating turbine base at the top of the tower or the rotating generator without major modifications to the existing tower's rotating-base structure at the top of the tower. The existing vertical propeller/generator bracing support strut already carries any wiring necessary to connect the rotating propeller/generator unit's electrical output to the rotating electrical pick up device fixed interiorly inside the turbine tower and out to the distribution network grid.

Existing rotating-base-to-electrical pick up devices are already in use and no modification to these devices would be required to attach the tunnel.

1. The only claim associated with this application is the act of attaching a hollow, lightweight-material, subsonic wind-tunnel-shaped structure to any existing electricity-generating wind turbine so as to enclose the existing propeller/generator/support strut or rotating generator unit near the minimum diameter (the “throat”) of the tunnel where the ambient wind speed is near its increased maximum.
NOTE: There is no claim in this application as to how the lightweight tunnel is manufactured or the material of which it is composed, or in what manner it is attached to the tower to enclose the propeller/generator/support-strut unit near the throat of the tunnel.
